(19) United States
(12) Patent Application Publication
(10) Pub. No.: US 2025/0347784 A1
(43) Pub. Date: Nov. 13, 2025

(54) SENSOR OUTPUT MODIFICATION

(71) Applicant: Ford Global Technologies, LLC, Dearborn, MI (US)

(72) Inventors: Shubhendra Chauhan, Newark, CA (US); Andrew Courtland Haworth, Washington, DC (US); Xiufeng Song, San Jose, CA (US)

(73) Assignee: Ford Global Technologies, LLC, Dearborn, MI (US)

(21) Appl. No.: 18/660,611

(22) Filed: May 10, 2024

(51) Int. Cl. G01S 7/487; G01S 13/86; G01S 17/08

(52) U.S. Cl. CPC G01S 7/4876; G01S 13/865; G01S 13/867; G01S 17/08

(57) ABSTRACT

A computer that includes a processor and a memory, the memory including instructions executable by the processor for actuating a component of a device based on a parameter output from a machine learning application trained with first output data from a first sensor that has been (1) modified in accordance with a first specified characteristic of the first sensor, and (2) modified in accordance with a second specified characteristic of a second sensor.

### BACKGROUND

Computers can operate mobile systems, which can include vehicles, robots, drones, and/or object tracking systems. Data including images, lidar measurement points, and radar range and velocity measurements can be acquired by sensors and processed by a computer to determine a location of a system with respect to an environment and with respect to static or moving objects in the environment. A computer may use the sensor data to determine one or more trajectories and/or actions for operating the system or device, or components thereof, in the environment.

### BRIEF DESCRIPTION OF THE DRAWINGS

FIG. 1 is a block diagram of an example first vehicle system.

FIG. 2 is a block diagram of an example second vehicle system.

FIG. 3 is a diagram of an example system for modifying a sensor measurement acquired by a first sensor.

FIG. 4 is a diagram showing differences in characteristics of sensors of first and second systems.

FIG. 5 is a diagram of an example process to modify a captured image from a first sensor.

FIG. 6 is a flowchart of an example process to modify sensor measurements from a first sensor.

FIG. 7 is a flowchart diagram of an example process to actuate a vehicle component of a second system based on a parameter uploaded from a training network.

### DETAILED DESCRIPTION

Systems that move and/or that include mobile components, including vehicles, robots, land-based or aerial drones, cell phones etc., can be operated by acquiring sensor data, including data with respect to an environment around the system, and processing the acquired sensor data to determine locations of objects in the environment around the system. The determined location data can be processed to guide operation of the system or portions thereof. For example, a robot may determine the location of a static or moving object near an arm of the robot. The determined location of the static or moving object location can be used by the robot to determine a path upon which to move a gripper to grasp the object. In another example, a first vehicle may determine a location of second vehicle traveling on a roadway. The first vehicle can use the location of the second vehicle to determine a path upon which to operate while maintaining a predetermined distance from the second vehicle. Alternatively or in addition, the first vehicle can actuate a display of the first vehicle to provide text and/or graphics that indicate the location and/or velocity of the second vehicle.

A vehicle computer, for example, may utilize input data acquired by one or more sensors to determine a location of a static or moving object located within the vehicle's environment. For example, a vehicle may utilize a lidar sensor that can provide output data representing a measurement point that indicates a distance between the lidar sensor and the static or moving objects. Output data from a lidar sensor can be complemented with output data from a radar sensor, for example, which may provide an indication of whether a detected object is at rest or is in motion with a particular velocity vector. Output data from a lidar sensor may be further complemented by output data from a camera, which may be utilized by a vehicle computer to classify a static or moving object, such as road markings, signposts, stationary vehicles, moving vehicles, bicyclists, natural objects, animals, etc. In an example, a vehicle computer can execute program steps that permit fusion of output data from sensors of different types or modalities, such as a camera, a lidar, a radar, etc., so as to provide a classification and/or location objects located within the vehicle's operating environment, e.g., within a field of view of the sensors.

In an example, a vehicle computer can utilize a machine learning system, such as a convolutional neural network, which is trained to classify static or moving objects in a driving environment based on images captured by a camera or another imaging device. In another example, a vehicle computer can be trained via a machine learning system to classify certain types of static or moving objects based on radar signals returned from an object. In another example, a vehicle computer can be trained via a machine learning system to classify certain types of static or moving objects based on a cloud of measurement points obtained by a lidar sensor. Further, a vehicle computer can be trained to suitably fuse output signals from multiple sensor device types, such as cameras sensors, radar sensors, lidar sensors, etc., so as to provide accurate indications of static or moving objects in a driving environment based on fusing output signals from the multiple sensor device types.

Training a machine learning system can involve utilizing a training dataset that includes numerous (e.g., thousands or even millions) of still or video camera images, numerous lidar measurement point clouds, numerous signals representing radar signal returns, and/or numerous other types of sensor measurements. In a training environment of a machine learning system for use in a vehicle, video and/or still images, lidar measurement point clouds, and data representing radar signal returns from static or moving objects, etc., may be gathered from sensors mounted at locations that represent actual sensor locations of the vehicle as the vehicle is to be utilized in a driving environment. In an example, a process to train a machine learning system to classify static or moving objects based on images from a camera mounted at a particular location on a vehicle may be expedited and/or enhanced by utilizing images collected by a camera that approximates (or even emulates) a camera of a vehicle intended for use in an actual traffic environment. In another example, a process to train a machine learning system to classify a static or moving object may be expedited and/or enhanced by utilizing training images captured by a camera having intrinsic characteristics (e.g., camera distortion, field-of-view, spectral filtering characteristics of the camera lens, etc.) that approximate (or even emulate) to the intrinsic parameters of a camera intended for use in an actual traffic environment. In another example, a process to train a machine learning system to classify a lidar measurement point cloud may be expedited utilizing a lidar sensor that approximates (or emulates) a lidar sensor mounted at a location on a vehicle that is similar or identical to a lidar sensor mounting location of a vehicle intended for use in an actual traffic environment.

Techniques described herein can be useful in expediting and/or enhancing training of a machine learning system by modifying measurements from a first sensor in accordance with a specified characteristic of the first sensor (e.g., of a first system) so as to accord with specified characteristics of a second sensor (e.g., of a second system) utilized in an actual operating environment. Accordingly, as described further herein, output data from a first sensor may be modified by transforming the output data from the first sensor to represent or approximate data acquired from a second sensor, which may include a sensor mounted, for example, on a vehicle intended for use in a traffic environment. Thus, a data set, which may include, for example, thousands or millions of camera images obtained from a first camera having a particular characteristic, and/or mounted at a particular location on a first vehicle, can be modified to provide images suitable for training a machine learning system that utilizes a second camera having particular characteristics and/or mounted at a different location on a second vehicle. Alternatively or in addition, a data set from a first vehicle, which may include thousands or millions of point clouds representing lidar measurements, data representing radar signal returns, or data representing output signals from another sensor can be modified to provide a data set suitable for training a machine learning system that utilizes a second sensor of a similar type mounted on a second vehicle.

In an example, a method can include actuating a component of a device based on a parameter output from a machine learning application that can be trained with first output data from a first sensor that has been (1) modified in accordance with a first specified characteristic of the first sensor, and (2) modified in accordance with a second specified characteristic of a second sensor.

The first specified characteristic of the first sensor can be a noise content of output data from the first sensor, a field-of-view of the first sensor, a detection range of the first sensor, a resolution of the first sensor, or a sampling interval of the first sensor.

The first output data from the first sensor that has been (1) modified in accordance with the first specified characteristic of the first sensor, and (2) modified in accordance with the second specified characteristic of the second sensor, can reference the first output data from a first specified reference point on a first vehicle to a second specified reference point on a second vehicle.

The first sensor can be a first lidar sensor and the second sensor can be a second lidar sensor.

The first specified characteristic can be a field-of-view of the first lidar sensor, the second specified characteristic can be a field-of-view of the second lidar sensor, and the first output data from the first sensor that has been (1) modified in accordance with the first specified characteristic of the first sensor, and (2) modified in accordance with the second specified characteristic of the second sensor, can be processed to omit measurement points within the field-of-view of the first lidar sensor that are outside the field-of-view of the second lidar sensor.

The first specified characteristic can be a detection range of the first lidar sensor, the second specified characteristic can be a detection range of the second lidar sensor, and the first output data from the first sensor that has been (1) modified in accordance with the first specified characteristic of the first sensor, and (2) modified in accordance with the second specified characteristic of the second sensor can omit measurement points representing a distance that is outside the detection range of the second lidar sensor.

The first specified characteristic can be a first scan interval of the first lidar sensor, the second specified characteristic can be a second scan interval of the second lidar sensor, and the first output data from the first sensor that has been (1) modified in accordance with the first specified characteristic of the first sensor, and (2) modified in accordance with the second specified characteristic of the second sensor can omit measurement points collected during the first scan interval that are outside the second scan interval.

The first specified characteristic can be a first scan resolution of the first lidar sensor, the second specified characteristic can be a second scan resolution of the second lidar sensor, and the first output data from the first sensor that has been (1) modified in accordance with the first specified characteristic of the first sensor, and (2) modified in accordance with the second specified characteristic of the second sensor can omit measurement points collected at the first scan resolution that is different from the second scan resolution.

The first sensor can be a first radar sensor and the second sensor can be a second radar sensor.

The first specified characteristic can be a first detection range of the first radar sensor, the second specified characteristic can be a second detection range of the second radar sensor, and the first output data from the first sensor that has been (1) modified in accordance with the first specified characteristic of the first sensor, and (2) modified in accordance with the second specified characteristic of the second sensor omit measurement points of the first detection range that are outside of the second detection range.

The first specified characteristic can be a first scan interval of the first radar sensor, the second specified characteristic can be a second scan interval of the second radar sensor, and the first output data from the first sensor that has been (1) modified in accordance with the first specified characteristic of the first sensor, and (2) modified in accordance with the second specified characteristic of the second sensor can align the first radar scan interval with the second radar scan interval.

The first sensor can be a first camera sensor and the second sensor can be a second camera sensor.

The first specified characteristic can be a first distortion parameter of the first camera sensor, the second specified characteristic can be a second distortion parameter of the second camera sensor, and the first output data from the first sensor that has been (1) modified in accordance with the first specified characteristic of the first sensor, and (2) modified in accordance with the second specified characteristic of the second sensor can apply the first distortion parameter to generate a first back projected pixel location. The second sensor can additionally apply the second distortion parameter to the generated back projected first pixel location.

The first specified characteristic can be a first pixel gain parameter of the first camera sensor, the second specified characteristic can be a second pixel gain parameter of the second camera sensor, and the first output data from the first sensor that has been (1) modified in accordance with the first specified characteristic of the first sensor, and (2) modified in accordance with the second specified characteristic of the second sensor can apply the first pixel gain parameter to generate a first back projected pixel gain value. The second sensor can additionally apply the second pixel gain parameter to the first back projected pixel gain value.

In an example, a system can include a computer including a processor and memory, the memory storing instructions executable by the processor to actuate a component of a device based on a parameter output trained with first output data from a first sensor that has been (1) modified in accordance with a first specified characteristic of the first sensor, and (2) modified in accordance with a second specified characteristic of a second sensor.

The first specified characteristic of the first sensor can be a noise content of output data from the first sensor, a field-of-view of the first sensor, a detection range of the first sensor, a resolution of the first sensor, or a sampling interval of the first sensor.

The first output data from the first sensor that has been (1) modified in accordance with the first specified characteristic of the first sensor, and (2) modified in accordance with the second specified characteristic of the second sensor can reference the first output data from a first specified reference point on a first vehicle to a second specified reference point on a second vehicle.

The first sensor can be a first radar sensor and the second sensor can be a second radar sensor.

The first sensor can be a first camera sensor and the second sensor can be a second camera sensor.

The first sensor can be a first lidar sensor and the second sensor can be a second lidar sensor.

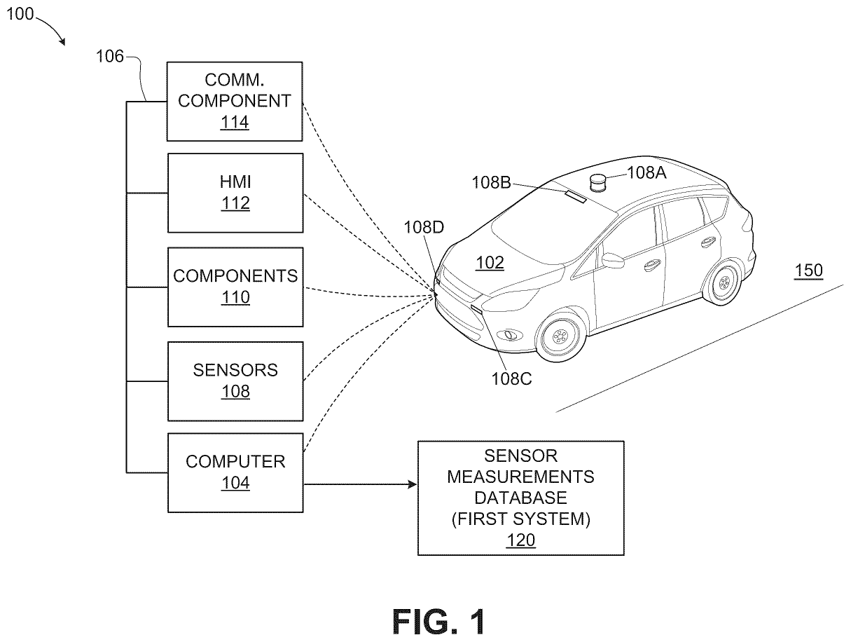

FIG. 1 is a block diagram of an example first vehicle system 100. First vehicle system 100 includes vehicle body 102, vehicle computer 104 included within vehicle body 102, and numerous sensors 108 mounted on vehicle body 102. First vehicle system 100 can represent any type of vehicle, such as a car, sport utility vehicle, truck, bus, or any other vehicle that can be operated on road 150. Sensors 108 can include lidar sensor 108A, camera sensor 108B, radar sensors 108C and 108D, and other sensors, such as wheel speed sensors, navigation sensors (e.g., sensors of a satellite positioning system, sensors of an inertial measurement unit, outside air temperature sensors, engine and drivetrain monitoring sensors etc.). Vehicle computer 104 can receive data regarding the operation of first vehicle system 100 from sensors 108 utilizing vehicle communications bus 106. Vehicle computer 104 may operate first vehicle system 100 based on data received from sensors 108 and actuate vehicle components 110, which can include vehicle steering components, vehicle propulsion components (i.e., control of speed and/or changes in speed of first vehicle system 100 by controlling one or more of an internal combustion engine, electric motor, hybrid engine, etc.), electrical and/or electrohydraulic engine and drivetrain components, climate control, vehicle internal and external lighting, etc. Vehicle computer 104 can additionally determine whether and when vehicle computer 104, as opposed to a human operator, is to control such operations.

Vehicle computer 104 can include one or more processors and memory such as are known. Further, a memory can include one or more forms of nonvolatile computer-readable media, which stores instructions executable by the processor for performing various operations, including as disclosed herein. Vehicle computer 104 can be generally arranged for communications on any suitable type of vehicle communication bus 106, i.e., including a controller area network (CAN), local interconnect network (LIN), or another suitable communications bus architecture. Vehicle communications bus 106 can include wired or wireless communication mechanisms such as are known, (i.e., Ethernet, Bluetooth or another communication protocol).

Via vehicle communications bus 106, vehicle computer 104 can transmit messages to various subsystems, components, and devices of first vehicle system 100 and can receive messages from the various devices, subsystems, components, i.e., controllers, actuators, sensors, etc., including sensors 108. Alternatively or additionally, in examples in which vehicle computer 104 actually includes multiple devices, vehicle communications bus 106 can be used for communications between devices represented as vehicle computer 104 in this disclosure. Further, as mentioned below, various controllers or sensing elements such as sensors 108 may provide data to vehicle computer 104 via vehicle communications bus 106.

In addition, vehicle computer 104 can be configured for communicating via a vehicle-to-infrastructure (V2I) interface utilizing communications component 114. A communications interface can include a wireless fidelity (WI-FI®) interface, a cellular network interface, a BLUETOOTH® interface, a Bluetooth Low Energy (BLE) interface, an Ultra-Wideband (UWB) communications interface, a peer-to-peer communications, and/or another interface utilizing wired and wireless packet networks or technologies. Vehicle computer 104 may be configured for communicating with other vehicles through a vehicle-to-everything (V2X) interface using vehicle-to-vehicle networks, i.e., according to or including cellular communications (C-V2X) wireless communications cellular, Dedicated Short Range Communications (DSRC), or the like, i.e., formed on an ad hoc basis among nearby vehicles or formed through infrastructure-based networks. Vehicle computer 104 can log data by storing the data in nonvolatile memory for later retrieval and transmittal via the vehicle communication network and a vehicle to infrastructure (V2I) interface.

Vehicle computer 104 can additionally communicate with human machine interface (HMI) 112 utilizing vehicle communications bus 106. In an example, responsive to communications from vehicle computer 104, HMI 112 can provide audio signals and/or activation of haptic actuator, such as a vibrating actuator on a steering wheel or in a cushion of vehicle system 100, to provide notifications to an operator of vehicle system 100.

Sensors 108 may include a variety of devices such as are known to provide data to vehicle computer 104 via vehicle communications bus 106. In the example of FIG. 1, sensor 108A can represent a lidar sensor, which provides measurement points representing a distance between lidar sensor 108A and a static or moving object located in a forward direction, in a rearward direction, or to a side of vehicle body 102. In an example, lidar sensor 108A can include numerous laser radiating elements (e.g., 16 lasers, 32 lasers, 64 lasers etc.) that provide a point cloud representing a plurality of measurement points each representing distances between lidar sensor 108A and a static or moving object in the traffic environment of vehicle system 100. Although lidar sensor 108A is indicated as being mounted on an externally facing surface of an upper structure of vehicle body 102, in other examples, lidar sensor 108A can be mounted on an externally facing surface of vehicle body 102, such as on the hood of vehicle body 102, a front grille of vehicle body 102, etc.

Sensors 108 can include a camera sensor, such as camera sensor 108B positioned near an upper boundary of the windshield of vehicle body 102. Camera sensor 108B can include a camera for capturing still or video scenes that include objects, such as stationary or moving vehicles, animals, natural objects, lane markings, traffic signs, etc., which are located external to vehicle body 102. In an example, camera sensor 108B can detect electromagnetic radiation in a range of wavelengths. For example, camera sensor 108B can detect visible light, infrared radiation, ultraviolet light, or a range of wavelengths including visible, infrared, and/or ultraviolet light. For example, camera sensor 108B can include image sensors such as charge-coupled devices (CCD), active-pixel sensors such as complementary metal-oxide semiconductor (CMOS) sensors, etc.

Sensors 108 can include radar sensors 108C and 108D mounted at opposite sides of a front bumper of vehicle body 102. In an example, radar sensors 108C and 108D can provide output data representing a distance (e.g., range) between a radar sensor and a static or moving object within the radar's field-of-view. Radar sensors 108C and 108D can additionally provide output data representing a velocity of an object within the radar's field-of-view.

Sensors 108 can include altimeters, ultrasonic sensors, infrared sensors, pressure sensors, accelerometers, gyroscopes, temperature sensors, hall sensors, mechanical sensors such as switches, etc. Such additional sensors can be utilized to provide output data representing the environment in which first vehicle system 100 operates. For example, certain sensors of sensors 108 can be utilized to detect phenomena such as weather conditions (precipitation, external ambient temperature, etc.), the grade of a road, the location of a road (i.e., using road edges, lane markings, etc.), or locations of static or moving objects such as neighboring vehicles. Certain sensors of sensors 108 can additionally collect data representing operations of first vehicle system 100, such as velocity, yaw rate, steering angle, engine speed, oil pressure, a power applied to components 110 of vehicle system 100, connectivity between components, and performance of components of vehicle system 100.

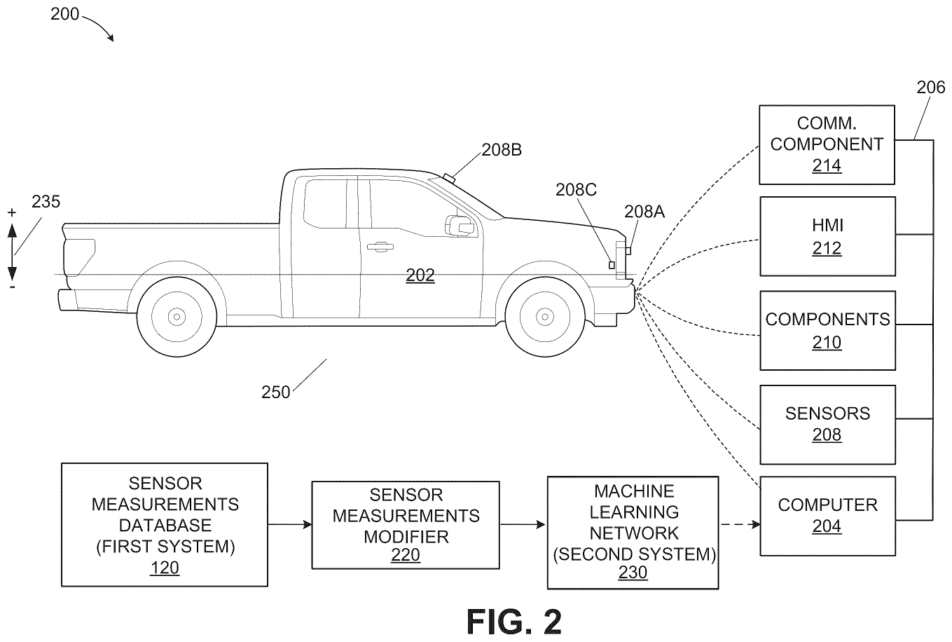

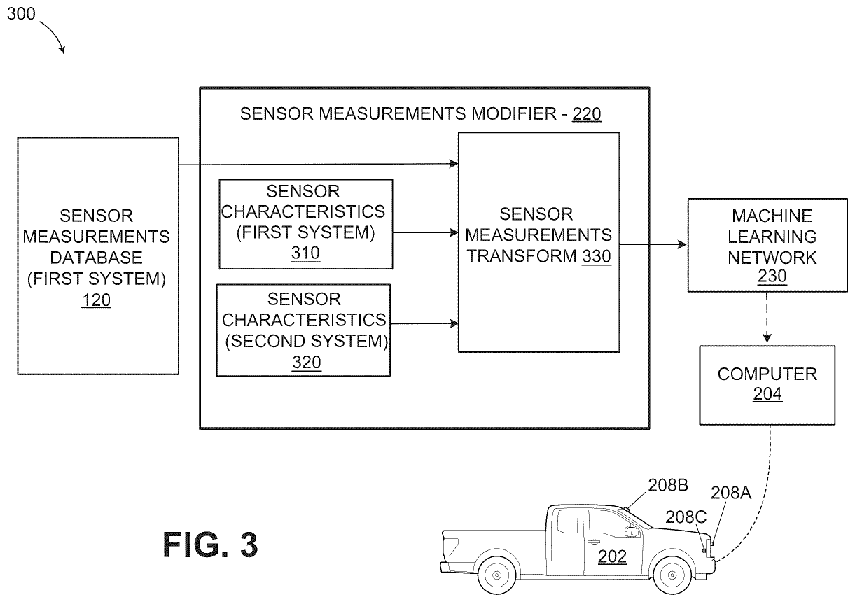

Vehicle computer 104 can additionally include a communications interface with sensor measurements database 120. In an example, while vehicle system 100 is in operation, sensor measurements, such as measurements performed by sensors 108 (e.g., lidar sensor 108A, camera sensor 108B, radar sensors 108C and 108D, etc.) can be stored for use in training a machine learning system. Accordingly, sensor measurements database 120 may store numerous sensor measurements, such as thousands of sensor measurements, millions of sensor measurements, etc. As described in relation to FIGS. 2-6, measurements acquired by sensors 108 of first vehicle system 100 may be modified, such as described in relation to FIG. 3, so as to approximate or to emulate sensor measurements performed by sensors of a second system, such as second vehicle system 200 of FIG. 2. Accordingly as described further herein, sensor measurements stored in sensor measurements database 120 represent measurements of a first system, such as a vehicle system, which may be modified and utilized to train a machine learning system for use with a second system, such as the system of FIG. 2.

FIG. 2 is a block diagram of an example second vehicle system 200. Second vehicle system 200 may include components, actuators, sensors, etc., which can be of a similar type as those of first vehicle system 100. Thus, second vehicle system 200 includes vehicle body 202, vehicle computer 204 included within vehicle body 202, and numerous sensors 208. Sensors 208 can include lidar sensor 208A, camera sensor 208B, radar sensors 208C and 208D, and other sensors, such as wheel speed sensors, navigation sensors (e.g., sensors of a satellite positioning system, sensors of an inertial measurement unit, outside air temperature sensors, engine and drivetrain monitoring sensors etc.).

Second vehicle system 200 can include a car, truck, sport utility vehicle, a bus, or any other vehicle capable of being operated on a roadway. In the example of FIG. 2, second vehicle system 200 includes vehicle body 202, which is larger in size than vehicle body 102. Second vehicle system 200 includes sensors (i.e., lidar sensor 208A, camera sensor 208B, and radar sensors 208C and 208D), some of which (e.g., lidar sensor 208A) may be mounted at locations on vehicle body 202 that are not in correspondence with mounting locations of similar sensors on or within vehicle system 100. In the example of FIG. 2, lidar sensor 208A is shown as being mounted at a front grille portion of vehicle body 202, which differs from the upper structure mounting of lidar sensor 108A shown in the example of FIG. 1. The example of FIG. 2 additionally shows camera sensor 208B mounted at an upper portion of the windshield of vehicle body 202. However, as a consequence of vehicle body 202 being larger in size than vehicle body 102, camera sensor 208B is positioned at a greater distance from road 250 than camera sensor 108B relative to road 150. Accordingly, the perspective of camera sensor 208B differs from the perspective of camera sensor 108B. Thus, images of static or moving objects captured by camera sensor 208B can appear differently than images of objects captured by camera sensor 108B. Likewise, as a consequence of vehicle body 202 being larger in size than vehicle body 102, radar sensors 208C and 208D are positioned at a greater distance from road 250 than radar sensors 108C and 108D relative to road 150. Accordingly, an elevation angle of arrival of radar signal returns from static or moving objects detected by radar sensors 208C and 208D can be different from the elevation angle of arrival of radar signal returns from objects captured by radar sensors 108C and 108D.

Vehicle computer 204 can receive data regarding the operation of second vehicle system 200 from sensors 108 utilizing vehicle communications bus 206. Vehicle computer 204 may operate vehicle system 200 based on data received from sensors 208 and actuate vehicle components 210, which can include vehicle steering components, vehicle propulsion components (i.e., control of speed and/or changes in speed in second vehicle system 200 by controlling one or more of an internal combustion engine, electric motor, hybrid engine, etc.), electrical and/or electrohydraulic engine and drivetrain components, climate control, vehicle internal and external lighting, etc. Vehicle computer 204 can additionally determine whether and when vehicle computer 104, as opposed to a human operator, is to control such operations.

Similar to vehicle computer 104, vehicle computer 204 can include one or more processors and memory. Further, a memory can include one or more forms of nonvolatile computer-readable media, which stores instructions executable by the processor for performing various operations, including as disclosed herein. Vehicle computer 204 can be generally arranged for communications on any suitable type of vehicle communications bus 206, i.e., including a controller area network (CAN), local interconnect network (LIN), or another suitable communications bus architecture. Vehicle communications bus 206 can include wired or wireless communication mechanisms such as are known, i.e., Ethernet, Bluetooth or other communication protocols.

Via vehicle communications bus 206, vehicle computer 204 can transmit messages to various subsystems, components, and devices of second vehicle system 200 and can receive messages from the various devices, subsystems, components, i.e., controllers, actuators, sensors, etc., including sensors 208. Alternatively or additionally, in examples in which vehicle computer 204 actually includes multiple devices, vehicle communications bus 206 can be used for communications between devices represented as vehicle computer 204 in this disclosure. Further, as mentioned below, various controllers or sensing elements such as sensors 208 may provide data to the vehicle computer 204 utilizing vehicle communications bus 206.

Vehicle computer 204 can be configured for communicating via a vehicle-to-infrastructure (V2I) interface utilizing communications component 214 via a WI-FI® interface, a cellular network interface, a BLUETOOTH® interface, a Bluetooth Low Energy (BLE) interface, an Ultra-Wideband (UWB) communications interface, a peer-to-peer communications, and/or another interface utilizing wired and wireless packet networks or technologies. Vehicle computer 204 may be configured for communicating with other vehicles through a vehicle-to-everything (V2X) interface using vehicle-to-vehicle networks, i.e., according to or including cellular communications (C-V2X) wireless communications cellular, Dedicated Short Range Communications (DSRC), or the like, i.e., formed on an ad hoc basis among nearby vehicles or formed through infrastructure-based networks. Vehicle computer 204 can log data by storing the data in nonvolatile memory for later retrieval and transmittal via the vehicle communication network and a vehicle to infrastructure (V2I) interface.

Vehicle computer 204 can additionally communicate with human machine interface (HMI) 212 utilizing vehicle communications bus 206. In an example, responsive to communications from vehicle computer 204, HMI 212 can provide audio signals and/or activation of haptic actuator, such as a vibrating actuator on a steering wheel or in a cushion of second vehicle system 200.

Sensors 208 may include a variety of devices such as are known to provide data to vehicle computer 204 via vehicle communications bus 206. In the example of FIG. 2, sensor 208A can represent a lidar sensor, which provides measurement points representing a distance between lidar sensor 208A and a static or moving object located in a forward direction, in a rearward direction, or to a side of vehicle body 202. In an example, lidar sensor 208A can include numerous laser radiating elements (e.g., 16 lasers, 32 lasers, 64 lasers etc.) that provide a point cloud representing a plurality of measurement points each representing distances between lidar sensor 208A and a static or moving object in the traffic environment of vehicle system 100. Although lidar sensor 208A is indicated as being mounted on an externally facing surface of a front grille portion of vehicle body 202, in other examples, lidar sensor 208A can be mounted on another externally facing surface of vehicle body 202, such as on the hood of vehicle body 202 an upper structure of vehicle body 202, etc.

In the example of FIG. 2, lidar sensor 208A is mounted to a front-facing grille of vehicle body 202. Accordingly, referring to FIG. 1, lidar measurement points collected utilizing lidar sensor 108A represent measurement points collected from a different perspective than lidar measurements collected utilizing lidar sensor 208A. Thus, sensor measurements modifier 220 can adjust locations of measurement points collected via lidar sensor 108A, e.g., in a negative (−) vertical direction along axis 235, so as to represent measurement points collected utilizing lidar sensor 208A. In another example also as seen in FIG. 2, as a consequence of vehicle body 202 being larger in size than vehicle body 102, camera sensor 208B may be mounted at a greater vertical distance from road 250 than camera sensor 108B with respect to road 150. Accordingly, images captured utilizing camera sensor 208B are collected from a different perspective than camera measurements collected utilizing camera sensor 108B. Thus, sensor measurements modifier 220 can adjust images captured via camera sensor 108B, e.g., in a positive (+) vertical direction along axis 235, so as to represent images collected via camera sensor 208B. In another example, also as a consequence of vehicle body 202 being larger in size than vehicle body 102, radar sensors 208C and 208D are mounted at a greater vertical distance from road 250 than radar sensors 108C and 108D with respect to road 150. Thus, sensor measurements modifier 220 can adjust radar signal returns captured via radar sensors 108C and 108D, e.g., in a positive (+) vertical direction along axis 235, so as to represent radar signal measurements collected utilizing radar sensors 208C and 208D. As described in reference to FIG. 3, sensor measurements modifier 220 can execute additional modifications, such as modifications to sensor fields-of-view, sensor sampling rates, sensor noise content, intrinsic sensor characteristics, etc., in accordance with specified characteristics of sensors 108 and 208. In this disclosure, the term “intrinsic” camera sensor parameter means characteristics internal to camera sensor 108B, 208B. Accordingly, camera sensor intrinsic parameters include focal length, skew, field-of-view, pixel resolution, pixel noise, pixel gain, aperture diameter, distortion, lens spectral filtering or shading, and camera sensor depth-of-field. In this disclosure, the term “extrinsic” camera parameter means characteristics external to camera sensor 108B, 208B. Accordingly, camera extrinsic parameters can include a camera mounting location on a vehicle system (e.g., vehicle system 100, 200), camera orientation, obstructions in the camera field-of-view, etc.

Thus, in the example of FIG. 2, sensor measurements from sensor measurements database 120, which represents sensor measurements collected utilizing first vehicle system 100, can be modified so as to approximate sensor measurements collected utilizing second system 200. Such modified sensor measurements, which may include thousands or millions of sensor measurements, can be input to machine learning system 230. Accordingly, as a result of such training utilizing modified sensor measurements collected by first vehicle system 100, machine learning system 230 can be trained to recognize or to classify static or moving objects measured utilizing sensors 208. After training of machine learning system 230, such as during a manufacturing or testing phase of system 200, machine learning system 230 can develop parameters that can be uploaded to a memory accessible to computer 204. Such parameters can assist vehicle computer 204 in classifying static or moving objects represented by point clouds resulting from lidar measurements, images (or features within images) from scenes captured via a camera sensor 208B, static or moving objects represented by signal returns from radar sensors 208C and 208D, etc.

In an example, machine learning system 230 can include a convolutional neural network. In this context, the convolutional neural network is a feed-forward artificial neural network with at least three layers (i.e., an input layer, an output layer, and at least one hidden layer). In an example, the input layer receives a set of measurement points from lidar sensor 108A, data representing images captured by camera sensor 108B, data representing return signals from radar sensor 108C, 108D, or another sensor of sensors 108 of first vehicle system 100. Output data can be representative of relatively large static objects or objects in motion (e.g., buses, cargo vehicles, etc.) as well as relatively small static or moving objects (e.g., bicycles, compact vehicles, etc.). Output signals can additionally represent objects moving at relatively low velocities, e.g., five kilometers per hour, 10 kilometers per hour, 15 kilometers per hour, as well as objects moving at larger velocities, such as velocities of 25 kilometers per hour, 30 kilometers per hour, 40 kilometers per hour, etc., with respect to first vehicle system 100.

Machine learning system 230 can compute a loss function that represents an ability of the machine learning system to accurately predict an expected output. The loss function can be back-propagated through hidden layers of machine learning system 230, incrementally altering the weights or settings stored at hidden layers of machine learning system 230, to minimize the loss function. In this context a “weight” or a “setting” means a parameter of a hidden layer of machine learning system 230 that at least partly controls or governs the transformation or output of data from system 230 by performing an operation, e.g., addition, multiplication, convolution, or another function, to provide data, e.g., at an output layer that can be observed by a human and/or computer 204 of second vehicle system 200. Responsive to the loss function being sufficiently minimized, machine learning system 230 may be considered to be trained, and the current parameters (e.g., formulated or derived from weights and/or settings within a hidden layer of machine learning system 230) can be uploaded for use by vehicle computer 204.

FIG. 3 is a diagram of an example system 300 for modifying a sensor measurement acquired by a first sensor. As shown in FIG. 3, sensor measurements modifier 220 includes sensor characteristics component 310, which includes a database, table, or other type of listing of characteristics of sensors of first vehicle system 100, e.g., sensors 108. In this context, the term “sensor characteristics” means data describing the sensor that can be relevant to interpreting output data from the sensor. For example, sensor characteristics can be a property that distinguishes a first sensor (e.g., 108A, 108B, 108C, 108D) from a second sensor (e.g., 208A, 208B, 208C, 208D). Sensor measurements modifier 220 includes sensor characteristics component 320, which similarly includes a database, table, or other type of listing of characteristics of sensors of second vehicle system 200, e.g., sensors 208. In an example, sensor characteristics included in sensor characteristics components 310, 320 can include sensor angular fields-of-view (e.g., 90°, 120°, 135°, etc.), sensor operating ranges (e.g., 50 meters to 100 meters, 100 meters to 500 meters, 250 meters to 750 meters, etc.), sensor sampling intervals and/or update rates (e.g., 10 hertz, 25 hertz, 50 hertz, etc.), camera sensor intrinsic parameters (e.g., focal length, skew, pixel gain, spectrally dependent lens shading, lens distortion, etc.), sensor noise content, as well as numerous other characteristics of sensors 108, 208. In the example of FIG. 3, outputs from sensor characteristics components 310 and 320 are input to sensor measurements transform component 330, which executes program instructions to modify outputs from sensor measurements database 120 so as to approximate or emulate sensor outputs from sensors 208 of second vehicle system 200. Modified sensor measurements collected by first vehicle system 100 can be utilized as training inputs to machine learning system 230, to train system 230 to classify static or moving objects measured utilizing sensors 208. Based on training of machine learning system 230, which may occur during a manufacturing or a testing phase of system 200, machine learning system 230 can develop parameters that can be uploaded to a memory accessible to computer 204. Utilizing such parameters, vehicle computer 204 can execute instructions to classify static or moving objects in the traffic environment of second vehicle system 200.

In an example, sensor measurements transform component 330 can align sampling intervals between lidar sensors 108A and 208A. For example, lidar sensor 108A may be specified to execute a lidar scan at 0.5 second intervals, and lidar sensor 208A may be specified to execute a lidar scan at 1.0 second intervals. In such an example, sensor characteristics component 310 can transmit data to indicate that lidar sensor 108A includes a scan interval of 0.5 seconds, and sensor characteristics component 320 can transmit data to indicate that lidar sensor 208A includes a scan interval of 1.0 seconds. Based on such inputs, instructions executed by sensor measurements transform component 330 can filter outputs from sensor measurements database 120 to omit lidar sensor measurement points collected outside of one-second intervals (e.g., 0.5 seconds, 1.5 seconds, 2.5 seconds, 3.5 seconds, etc.) so as to output lidar measurement points collected at one-second intervals (e.g., 1.0 seconds, 2.0 seconds, 3.0 seconds, etc.), omitting the measurement points collected outside of the one-second intervals. Filtered output signals from sensor measurements transform component 330 may then be input to machine learning system 230, which may permit system 230 to be trained utilizing lidar measurements points collected at one-second intervals so as to approximate output data from lidar sensor 208A.

In another example, sensor measurements transform component 330 can modify scan resolution characteristics of lidar sensor 108A. For example, lidar sensor 108A may be specified to include a scan resolution of 1.0 centimeter, and lidar sensor 208A may be specified to include a scan resolution of 2.0 centimeter. In such an example, instructions executed by sensor measurements transform component 330 can filter outputs from sensor measurements database 120 to adjust output data from sensor measurements database 120 so as to output lidar measurements representing a 2.0 centimeter scan resolution. Filtered output signals from sensor measurements transform component 330 may then be input to machine learning system 230, which may permit system 230 to be trained utilizing lidar measurements that include a 2.0-centimeter scan resolution, such as measurement points from lidar sensor 208A.

In another example, sensor measurements transform component 330 can modify specified characteristics of camera images captured by camera sensor 108B. For example, camera sensor 108B may be specified to include a pixel gain value of 1.8 e-/count, and camera sensor 208B may be specified to include a pixel gain value of 2.0 e-/count. In such an example, instructions executed by sensor measurements transform component 330 can increase pixel gain values of camera image files from sensor measurements database 120 to increase pixel gain values of stored images (e.g., by approximately 11%) so as to output image files having pixel gain values of 2.0 e-/count.

In another example, sensor measurements transform component 330 can modify specified noise and/or characteristics of one or more of sensors 108. In an example, lidar sensor 108A may be specified to include a noise-induced uncertainty in position of a measured point of 0.5 centimeter, and lidar sensor 208A may be specified to include a noise-induced uncertainty in position of a measured point of 1.0 centimeter. In such an example, sensor measurements transform component 330 can modify measurement points e.g., of a lidar measurement point cloud, so as to provide an apparent increase an uncertainty in output data representing measurement points from lidar sensor 108A. In another example, camera sensor 108B may be specified to include a pixel noise content of 1.0 e-/count, and camera sensor 208B may be specified to include a pixel noise content of 1.5 e-/count. In such an example, instructions executed by sensor measurements transform component 330 can add pixel noise to output data representing camera images so as to provide an apparent increase in pixel noise content of images from camera sensor 108B. In another example, radar sensors 108C and 108D may be specified to include a range uncertainty of 5.0 centimeter, and radar sensors 208C and 208D may be specified to include a range uncertainty of 5.5 centimeter. In such an example, instructions executed by sensor measurements transform component 330 can add range uncertainty to output data representing a range (or a velocity of a moving object based on successive range measurements) so as to provide an apparent increase in range uncertainty of detected objects by radar sensors 108C and 108D.

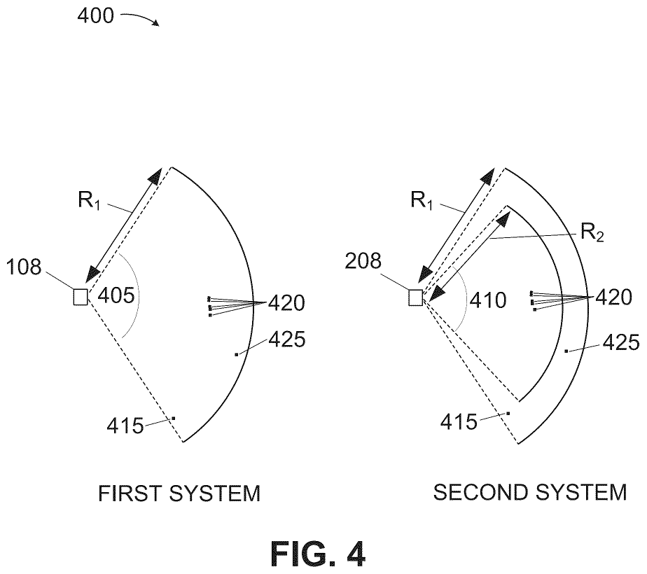

FIG. 4 is a diagram 400 showing differences in characteristics of sensors of first and second systems. In the example of FIG. 4, sensor 108 can represent lidar sensor 108A, radar sensor 108C, radar sensor 108D, or another sensor of first system 100. Sensor 108 can include a specified field-of-view 405 in azimuth of, for example, 110°, 120°, 135°, etc., and can include a specified maximum detection range of, for example, 200 meters. In an example, sensor 108 has determined that points 420 are located at a distance of approximately 140 meters from sensor 108, point 415 is located at a distance of 145 meters from sensor 108, and point 425 is located at a distance of 160 meters from sensor 108A. Measurements represented by points 415, 420, and 425 can be stored in sensor measurements database 120. Points 415, 420, and 425 can represent, for example, points of a lidar point cloud or can represent radar signal returns from static or moving objects in a traffic environment of first vehicle system 100.

Sensor 208 of FIG. 4 can represent lidar sensor 208A, radar sensor 208C, radar sensor 208D, or another sensor of second system 200. Sensor 208 can include a specified field-of-view 410 that is less than field-of-view 405, such as, for example, 90°, 100°, 105°, etc. In addition, sensor 208 can include a specified maximum detection range of, for example, 150 meters. Accordingly, in an example, in a process of training machine learning system 230 to recognize and/or classify objects within field-of-view 410, instructions executed by sensor measurements transform component 330 can remove measurement points 415 and 425, which are outside of the field-of-view of sensor 208. In addition, instructions executed by sensor measurements transform component 330 can remove sensor measurement points that lie outside of the specified azimuth range of sensor 208. That is, the removed sensor measurement points can be omitted from the training data.

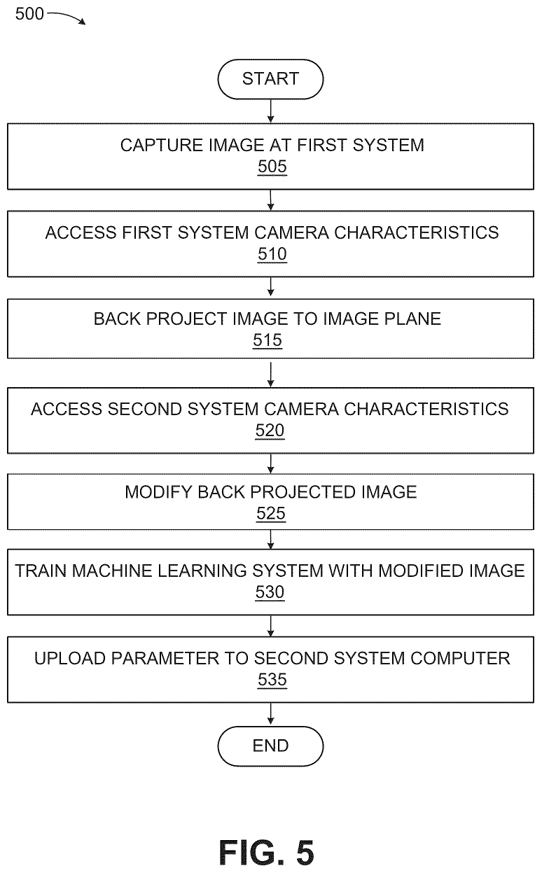

FIG. 5 is a diagram of an example process (500) to modify a captured image. In an example, camera sensor 108B of first vehicle system 100 can capture an image of an object in a traffic environment of system 100. The captured image can be stored in sensor measurements database 120. Sensor measurements transform component 330 can access output data representing the image from sensor measurements database 120 and execute instructions to modify the output data in accordance with data from sensor characteristics component 310. In an example, modifications can involve back projecting a captured image to an image plane utilizing distortion parameters (e.g., lens distortion parameters that may include spectral shading, skew, etc.) so as to obtain a raw pixel image at the image plane. The back projected raw pixel image can then be modified in accordance with specified characteristics obtained from sensor characteristics component 320, which applies distortion parameters of camera sensor 208B. The image modified in accordance with sensor characteristics component 320 can then be utilized in a process to train machine learning system 230 utilizing images that appear to have been captured utilizing camera sensor 208B.

Process 500 begins at block 505, which includes capturing an image utilizing camera sensor 108B of first vehicle system 100. Block 505 can additionally include storing output data representing the captured image in sensor measurements database 120.

Process 500 continues at block 510, which includes accessing characteristics of a camera of a first vehicle system 100. Camera characteristics can include distortion characteristics of a camera lens (e.g., an angular displacement in a first direction for a pixel in an image plane based on the pixel position relative to a camera boresight axis), spectral filtering of a lens, camera focal length, camera skew, pixel gain values, pixel noise characteristics, pixel color mapping, etc. Characteristics of camera sensor 108B can additionally include camera azimuthal field-of-view (in degrees), camera sensor range (in meters), etc.

Process 500 continues at block 515, which includes back projecting a captured image to an image plane. In a back projecting process, data representing a captured image can be modified to reverse distortion (e.g., applying and angular displacement in a second direction that is opposite the first direction for a pixel in an image plane based on the pixel relative to the camera boresight axis), amplification of pixel values to reverse spectrum-dependent lens shading, modifying camera focal length, correcting for camera skew and/or inserting different values for camera skew, processing pixel values to insert or reduce noise, inverting a pixel color map, etc. In an example, block 515 can include executing a geometry-based transform computation to reference output data representing a captured image from a first specified reference point on first vehicle system 100 to a second specified reference point of second vehicle system 200.

Process 500 continues at block 520, which includes sensor measurements transform component 330 accessing sensor characteristics of camera sensor 208B. Camera characteristics can include distortion characteristics of the lens of camera sensor 208B (e.g., an angular displacement of a pixel in an image plane based on the pixel relative to a camera boresight axis), spectral filtering by a camera lens, camera focal length, camera skew, pixel gain values, pixel noise characteristics, pixel color mapping, etc. Characteristics of camera sensor 208B can additionally include camera azimuthal field-of-view (in degrees), camera sensor range (in meters), etc.

Process 500 continues at block 525, which includes modifying a back projected image in accordance with camera characteristics accessed at block 520. Modifying a back projected image can include applying lens distortion characteristics of camera sensor 208B applying spectrally dependent amplification of pixel values, modifying camera focal length, correcting for camera skew and/or inserting different values for camera skew, processing pixel values to insert or reduce noise, inverting a pixel color map, etc.

Process 500 continues at block 530, which includes inputting modified images to train machine learning system 230. Based on training inputs, machine learning system 230 can develop parameters that can be uploaded to a memory accessible to computer 204. Such parameters can assist vehicle computer 204 in classifying static or moving objects represented by point clouds resulting from lidar measurements, images (or features within images) from scenes captured via a camera sensor 208B.

Process 500 continues at block 535, which includes uploading a parameter to second vehicle system 200. In an example, a parameter uploaded to second vehicle system 200 can assist vehicle computer 204 in recognizing and/or classifying objects detected via camera sensor 204B.

After executing block 535, process 500 ends.

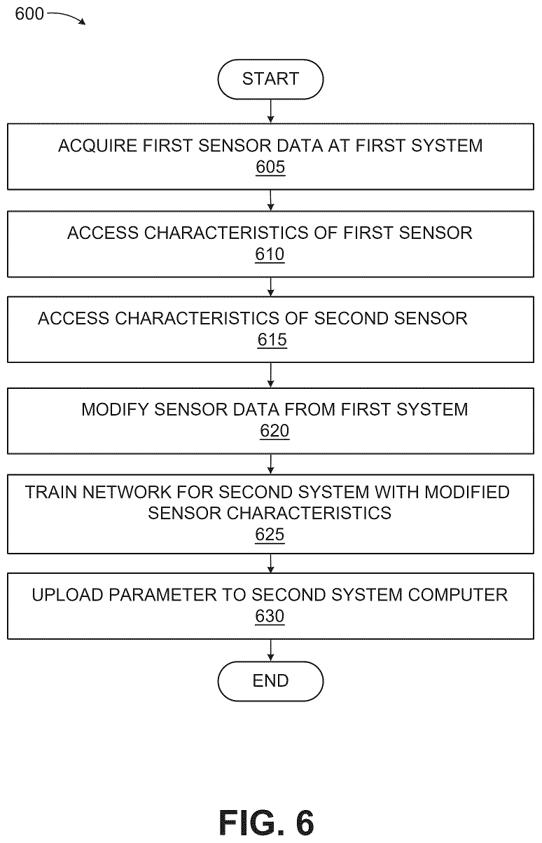

FIG. 6 is a flowchart of an example process to train a network that uploads a parameter to a second system. In an example, lidar sensor 108A of first vehicle system 100 can output data representing one or more measurement points of a lidar point cloud that represents an object detected in a traffic environment of first vehicle system 100. In another example, one or more of radar sensors 108C, 108D of first vehicle system 100 can output data representing return signals reflected from an object in a traffic environment. In such examples, output data from the sensors (108A, 108C, 108D) can be stored in sensor measurements database 120. In an example, measurements transform component 330 can access output data from the sensors and execute instructions to modify the output data in accordance with data from sensor characteristics components 310, 320. In another example, modifications can include modifying a sensor field-of-view to omit first sensor measurements of the first sensor that are outside of the field-of-view of the second sensor. In another example, modifications can include modifying sensor measurements from lidar measurement points or radar signal returns from objects located at a distance that is outside of the range of the second sensor. In other examples, modifications can include adjusting a scan resolution of the first sensor, increasing or decreasing the noise content of data from the first sensor, removing data collected at sampling intervals of a first sensor that are different from sampling rates of a second sensor, etc. After modifications, including omitting removed data, making adjustments, etc., sensor measurements can be utilized to train machine learning system 230. Based on training of machine learning system 230, the machine learning system can upload a parameter to second vehicle system 200.

Process 600 begins at block 605, which includes acquiring and/or storing sensor measurements, such as measurement points of a lidar point cloud, returned radar signals, or another signal indicating a measurement of an object in a traffic environment. Sensor measurements can be stored in sensor measurements database 120 for first vehicle system 100.

Process 600 continues at block 610, which includes accessing characteristics of the first sensor (108A, 108C, 108D) of the first vehicle system 100. Characteristics can include the field-of-view of the first sensor, the detection range of the first sensor, the noise content of measurements from the first sensor, the sampling rate or sampling intervals of the first sensor, the scan resolution of measurements executed by the first sensor, etc.

Process 600 continues at block 615, which includes accessing characteristics of a second sensor (e.g., 208A, 208C, 208D). Characteristics can include the field-of-view of the first sensor, the detection range of the first sensor, the noise content of measurements from the first sensor, the sampling rate or sampling intervals of the first sensor, the scan resolution of measurements executed by the first sensor, etc.

Process 600 continues at block 620, which includes sensor measurements transform component 330 modifying sensor measurements to represent sensor measurements collected from a second sensor (e.g., 208A, 208C, 208D) of second vehicle system 200. In an example, modification of sensor measurements can include removing sensor measurements of the first sensor of first vehicle system 100 that are outside of the field-of-view of the second sensor of second vehicle system 200. In another example, modifications can include modifying sensor measurements from lidar measurement points or radar signal returns from objects located at a distance that are outside of the range of the second sensor. In other examples, modifications can include adjusting a scan resolution of the first sensor, increasing or decreasing the noise content of data from the first sensor, removing data collected at sampling intervals of a first sensor that are different from sampling rates of a second sensor, etc.

Process 600 continues at block 625, which includes training machine learning system 230 utilizing sensor data modified at block 620. In an example, training of machine learning system 230 can include the use of thousands or even millions of output data sets representing numerous modified lidar point clouds, modified radar signal returns, or other modified output data sets from sensors 108 of first vehicle system 100. Responsive to a loss function of machine learning system 230 being sufficiently minimized, the current parameters (e.g., formulated or derived from weights and/or settings within a hidden layer of machine learning system 230) can be uploaded, at block 630, for use by vehicle computer 204 of second vehicle system 200.

After uploading parameters to vehicle computer 204 of second system 200, process 600 ends.

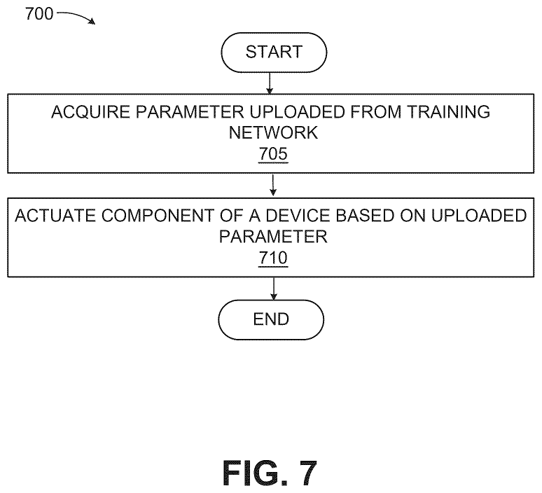

FIG. 7 is a flowchart diagram of an example process 700 to actuate a vehicle component based on a parameter uploaded from a training network. In process 700, parameters uploaded from machine learning system 230 can be utilized by second vehicle computer 204 to execute assisted driving of second vehicle system 200. For example, computer 204 may actuate a display of second vehicle system 200 to notify an operator of system 200 of static or moving objects in the traffic environment of second vehicle system 200. In another example, computer 204 may actuate steering components, propulsion components, or another control component without input from an operator of second vehicle system 200.

Process 700 begins at block 705, which includes computer 204 of second vehicle system 200 acquiring parameters uploaded to a memory accessible by computer 204.

Process 700 continues at block 710, wherein computer 204 actuates the display of second vehicle system 200, which notifies an operator of system 200 of a static or moving object in a traffic environment. Such notification can include, for example, displaying text or symbols to classify a static or moving object, displaying a velocity of a moving object, displaying a direction of a moving object, etc. Alternatively or in addition, computer 204 can actuate a steering component, a propulsion component, etc., based on second vehicle system 200 being in an assisted operating mode in which the computer 204 executed programming to actuate such component(s).

After executing block 710, process 700 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above and can be accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A method, comprising:
actuating a component of a device based on a parameter output from a machine learning application trained with first output data from a first sensor that has been (1) modified in accordance with a first specified characteristic of the first sensor, and (2) modified in accordance with a second specified characteristic of a second sensor.

2. The method of claim 1, wherein the first specified characteristic of the first sensor is a noise content of output data from the first sensor, a field-of-view of the first sensor, a detection range of the first sensor, a resolution of the first sensor, or a sampling interval of the first sensor.

3. The method of claim 1, wherein the first output data from the first sensor that has been (1) modified in accordance with the first specified characteristic of the first sensor, and (2) modified in accordance with the second specified characteristic of the second sensor, reference the first output data from a first specified reference point on a first vehicle to a second specified reference point on a second vehicle.

4. The method of claim 1, wherein the first sensor is a first lidar sensor and wherein the second sensor is a second lidar sensor.

5. The method of claim 4, wherein the first specified characteristic is a field-of-view of the first lidar sensor, wherein the second specified characteristic is a field-of-view of the second lidar sensor, and wherein the first output data from the first sensor that has been (1) modified in accordance with the first specified characteristic of the first sensor, and (2) modified in accordance with the second specified characteristic of the second sensor, has been processed to omit measurement points within the field-of-view of the first lidar sensor that are outside the field-of-view of the second lidar sensor.

6. The method of claim 4, wherein the first specified characteristic is a detection range of the first lidar sensor, wherein the second specified characteristic is a detection range of the second lidar sensor, and wherein the first output data from the first sensor that has been (1) modified in accordance with the first specified characteristic of the first sensor, and (2) modified in accordance with the second specified characteristic of the second sensor omit measurement points representing a distance that is outside the detection range of the second lidar sensor.

7. The method of claim 4, wherein the first specified characteristic is a first scan interval of the first lidar sensor, wherein the second specified characteristic is a second scan interval of the second lidar sensor, and wherein the first output data from the first sensor that has been (1) modified in accordance with the first specified characteristic of the first sensor, and (2) modified in accordance with the second specified characteristic of the second sensor omit measurement points collected during the first scan interval that are outside the second scan interval.

8. The method of claim 4, wherein the first specified characteristic is a first scan resolution of the first lidar sensor, and wherein the second specified characteristic is a second scan resolution of the second lidar sensor, and wherein the first output data from the first sensor that has been (1) modified in accordance with the first specified characteristic of the first sensor, and (2) modified in accordance with the second specified characteristic of the second sensor omit measurement points collected at the first scan resolution that is different from the second scan resolution.

9. The method of claim 1, wherein the first sensor is a first radar sensor and wherein the second sensor is a second radar sensor.

10. The method of claim 9, wherein the first specified characteristic is a first detection range of the first radar sensor, wherein the second specified characteristic is a second detection range of the second radar sensor, and wherein the first output data from the first sensor that has been (1) modified in accordance with the first specified characteristic of the first sensor, and (2) modified in accordance with the second specified characteristic of the second sensor omit measurement points of the first detection range that are outside of the second detection range.

11. The method of claim 9, wherein the first specified characteristic is a first scan interval of the first radar sensor, wherein the second specified characteristic is a second scan interval of the second radar sensor, and wherein the first output data from the first sensor that has been (1) modified in accordance with the first specified characteristic of the first sensor, and (2) modified in accordance with the second specified characteristic of the second sensor align the first radar scan interval with the second radar scan interval.

12. The method of claim 1, wherein the first sensor is a first camera sensor and wherein the second sensor is a second camera sensor.

13. The method of claim 12, wherein the first specified characteristic is a first distortion parameter of the first camera sensor, wherein the second specified characteristic is a second distortion parameter of the second camera sensor, and wherein the first output data from the first sensor that has been (1) modified in accordance with the first specified characteristic of the first sensor, and (2) modified in accordance with the second specified characteristic of the second sensor:
apply the first distortion parameter to generate a first back projected pixel location; and
apply the second distortion parameter to the generated first back projected pixel location.

14. The method of claim 12, wherein the first specified characteristic is a first pixel gain parameter of the first camera sensor, wherein the second specified characteristic is a second pixel gain parameter of the second camera sensor, and wherein the first output data from the first sensor that has been (1) modified in accordance with the first specified characteristic of the first sensor, and (2) modified in accordance with the second specified characteristic of the second sensor:
apply the first pixel gain parameter to generate a first back projected pixel gain value; and
apply the second pixel gain parameter to the first back projected pixel gain value.

15. A system, comprising a computer including a processor and memory, the memory storing instructions executable by the processor to:
actuate a component of a device based on a parameter output trained with first output data from a first sensor that has been (1) modified in accordance with a first specified characteristic of the first sensor, and (2) modified in accordance with a second specified characteristic of a second sensor.

16. The system of claim 15, wherein the first specified characteristic of the first sensor is a noise content of output data from the first sensor, a field-of-view of the first sensor, a detection range of the first sensor, a resolution of the first sensor, or a sampling interval of the first sensor.

17. The system of claim 15, wherein the first output data from the first sensor that has been (1) modified in accordance with the first specified characteristic of the first sensor, and (2) modified in accordance with the second specified characteristic of the second sensor reference the first output data from a first specified reference point on a first vehicle to a second specified reference point on a second vehicle.

18. The system of claim 15, wherein the first sensor is a first radar sensor and wherein the second sensor is a second radar sensor.

19. The system of claim 15, wherein the first sensor is a first camera sensor and wherein the second sensor is a second camera sensor.

20. The system of claim 15, wherein the first sensor is a first lidar sensor and wherein the second sensor is a second lidar sensor.
